(19) United States
(12) Patent Application Publication
(10) Pub. No.: US 2011/0031858 A1
(43) Pub. Date: Feb. 10, 2011

(54) ELASTICITY MODULE, SLIDE OPENING/CLOSING APPARATUS AND PORTABLE APPLIANCE UTILIZING THE ELASTICITY MODULE

(76) Inventor: Han Sang Lee, Seoul (JP)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/988,606

(22) PCT Filed: Apr. 16, 2009
(86) PCT No.: PCT/KR2009/001983

§ 371 Date: Oct. 19, 2010

(30) Foreign Application Priority Data
May 2, 2008 (KR) 10-2008-0041464

(51) Int. Cl. A47B 96/00; H01F 7/20; F16H 21/54; E05D 15/00

(52) U.S. Cl. 312/319.1; 335/285; 74/100.1; 49/414

(57) ABSTRACT

An elasticity module suitable to be used as a spring of a slide opening/closing apparatus of mobile devices such as wireless phone, PDA, PMP, portable game machine, electronic scheduler is provided. The elasticity module includes: a spring arm portion comprising first and second spring arms combined so as to have a sliding zone in which at least parts of them latch each other slidingly in an overlapped position; and a spring disposed between the first and second spring arms for applying an elasticity to in-between the first and second spring arms by an elastic deformation through the first spring arm's translation against the second spring arm over at least a part of the sliding zone, which can use a variety of springs, in which a moving range is larger for a size of the spring and it is easy to adjust the magnitude of the elasticity, which it is able to adjust the magnitude of the elasticity for a same size, which is stable in operation, which is tough against a vertical force, and which enables the slide cover open by two steps or vertically with the elasticity module.

### TECHNICAL FIELD

The invention relates to an elasticity module, more specifically to elasticity modules suitable to be used as a spring of a slide opening/closing apparatus of mobile devices such as wireless phone, PDA, PMP, portable game machine, electronic scheduler, slide opening/closing apparatus using the elasticity module, and mobile devices using them.

### BACKGROUND ART

In general, a traditional torsion spring used in a slide opening/closing device is made by winding a spring wire with high elasticity like a steel wire circularly or spirally, and usually includes a winding portion of wire wound circularly or spirally and an extending arm extended from the winding portion outwardly.

A spring wire used as a torsion spring in a slide opening/closing apparatus has 0.5 mm of diameter, and sometimes 0.45 mm of diameter is used to reduce a thickness of the slide opening/closing apparatus. In case of using a spring wire with a diameter smaller than 0.45 mm to make the torsion spring, a torsion moment for pushing the sliding member is too small, and the torsion spring tends to be strained and turned inside out due to overlapped portion. In this case, the torsion spring generates a large frictional force against a guiding member or a sliding member in a rotational operation, and makes it hard to assemble.

Also, due to the overlapped portion, the extending arm of the traditional torsion spring is disposed tilted outwardly from the winding portion. Therefore, when the extending arm rotates, one side of the winding portion tends to be lifted upward. For these reasons, an interval twice larger than the diameter of the spring wire is needed between the guiding member and the sliding member. Usually an interval about thee times higher than the diameter of the spring wire for redundancy in operation. This works as an obstacle in reducing a thickness of the slide opening/closing apparatus or a final product such as a mobile phone using the slide opening/closing apparatus.

And the traditional torsion spring is difficult to wind several times because the extending arm must stick out from the winding portion. With reduced number of windings, however, a degree of distribution of stress is lowered and elasticity by the torsion moment of the winding portion is also reduced.

Additionally, since the magnitude of the elasticity of the traditional torsion spring depends mainly on thickness of the spring wire, diameter of the winding portion, and number of windings, it becomes hard to adjust the magnitude of elasticity flexibly when torsion springs of a same size were made with a spring wire of same thickness.

Another wave-type spring was developed and used, but that also has a problem in increasing the magnitude of elasticity except for by increasing the thickness of the spring wire.

In addition, the traditional spring is weak against a vertical force or strain, and since the spring wire is used while exposed externally there was a problem of stability. Also, in order to have elasticity large enough to be used in slide opening/closing apparatus of mobile device, the traditional springs must be made very large.

### DISCLOSURE OF INVENTION

### Technical Problem

An object of the invention is to provide an elasticity module, which can be reduced in size compared to the traditional springs.

Another object of the invention is to provide an elasticity module, which uses various types of springs and magnets.

Still another object of the invention is to provide an elasticity module, which can be made with a large or small thickness according to usage.

Still another object of the invention is to provide various elasticity modules, which can be made with same springs and magnets according to usage.

Still another object of the invention is to provide an elasticity module, which provides a larger operation range than expected with sizes of the springs and magnets.

Still another object of the invention is to provide an elasticity module, which can adjust the magnitude of elasticity with a same size.

Still another object of the invention is to provide an elasticity module, which provides elasticity along a linear or curved line using a torsion spring.

Still another object of the invention is to provide an elasticity module, which is tough against a vertical force.

Still another object of the invention is to provide an elasticity module, which an arm of a torsion spring is not exposed externally.

Still another object of the invention is to provide an elasticity module, which can be designed adjusting a direction of an elastic force of a spring.

Still another object of the invention is to provide a slide opening/closing apparatus suitable to be used in mobile devices with elasticity module according to the invention.

Still another object of the invention is to provide a slide opening/closing apparatus enabling two step opening.

Still another object of the invention is to provide mobile devices having elasticity modules according to the invention.

Other object of the invention is to provide mobile devices enabling two step or both upward and downward opening of a movable body.

### Technical Solution

An elasticity module according to the invention includes: a spring arm portion comprising first and second spring arms combined so as to have a sliding zone in which at least parts of them latch each other slidingly in an overlapped position; and a spring disposed between the first and second spring arms for applying an elasticity to in-between the first and second spring arms by an elastic deformation through the first spring arm's translation against the second spring arm over at least a part of the sliding zone.

The spring may comprise one, two, or more selected from a group of: a torsion spring comprising a winding portion which is wound spirally; a torsion spring comprising a winding portion wound spirally and an extending arm extended outwardly from the winding portion at an outside end of the winding portion; a torsion spring comprising a winding portion wound spirally, a first extending arm extended outwardly from the winding portion at one end of the winding portion, and a second extending arm extended outwardly from the winding portion at another end of the winding portion; a torsion spring comprising a first winding portion wound spirally, a second winding portion connected to the first winding portion and wound spirally, a first extending arm extended outwardly from the first winding portion at one end of the first winding portion, and a second extending arm extended outwardly from the second winding portion at another end of the second winding portion; a bow-type spring; a circular spring with a portion which is curved in a circle; and a wave-type spring with bent portions alternatingly with intervals.

In certain embodiments, the elasticity module according to the invention may comprise: a spring arm portion comprising first and second spring arms combined so as to have a sliding zone in which at least part of them latch each other slidingly in an overlapped position; a rotating member connected to the first spring arm or the second spring arm so as to rotate in place; and a spring with one end connected to the rotating member and the other end connected to one of the first and second spring arms which is not connected to the rotating member.

In another certain embodiments, the elasticity module according to the invention may comprise: a spring arm portion comprising first and second spring arms combined so as to have a sliding zone in which at least part of them latch each other slidingly in an overlapped position; a connecting member disposed between the first spring arm and the second spring arm; a first spring with one end connected to the connecting member and the other end connected to one of the first and second spring arms; and a second spring with one end connected to the other end of the connecting member and the other end connected to one of the first and second spring arms which is not connected to the first spring.

Two or more springs of the above may be disposed with interval in the left-right direction.

Two or more springs may be disposed as one stacked on top of the other.

At least one of the first spring arm and the second spring arm may comprise a connector configured to be connected to other member.

At least one of the first spring arm and the second spring arm may comprise a bump extended sideway, and the bump may have a connector configured to be connected to other member.

In a certain embodiment, the first spring arm may comprise a stopper for limiting to moving distance of the second spring arm, the second spring arm may comprise a latch configured to hook the stopper.

The first spring arm or the second spring arm may comprise hole, bumps, or rotational axle type connectors.

In a certain embodiment, the spring may be connected to the first spring arm and the second spring arm rotatably.

In a certain embodiment, the spring may be connected to the first spring arm and the second spring arm rotatably, such that the direction of elastic force in the sliding zone changes according to rotating angle.

In a certain embodiment of the invention, an elasticity module may comprise a sliding zone in which at least some portions latch each other slidingly in an overlapped position, and further a first magnet arm and a second magnet arm with a magnetic force zone in which exert repelling or attracting force to each other along a sliding direction in the sliding zone.

In this embodiment, the first magnet arm and the second magnet arm may be magnets for themselves, or comprise magnets attached to them.

In a certain embodiment, the elasticity module may further comprise a spring disposed between the first and second magnet arms for applying elasticity to in-between the first and second magnet arms by an elastic deformation through the first magnet arm's translation against the second magnet arm over at least a part of the sliding zone.

A slide opening/closing apparatus according to the invention may comprise: a guiding member having a guiding means; a sliding member combined to the guiding means and installed so as to move; and an elasticity module according to the invention disposed between the guiding member and the sliding member, configured to push the sliding member in at least one direction of the guiding means in at least part of zone when the sliding member moves along the guiding means.

In this embodiment, the elasticity module may comprise a spring connected to each of the first spring arm and the second spring arm rotatably and installed so as to change a direction of elastic force according to the rotating angle of the spring, and the first spring arm is connected to the guiding member rotatably, and the second spring arm is connected to the sliding member rotatably.

In the slide opening/closing apparatus, until the sliding member moves along the guiding means and opens from a closed state, or until the sliding member opens upward from a closed state after opened downward initially, the elasticity module may comprise a first zone in which a distance between connectors on both ends decreases and a second zone in which the distance increases, and the spring may be installed so as to change directions of the elastic force on the second spring arm through a rotational operation during each the first zone and the second zone, being configured to open in two steps or upwardly and downwardly.

A mobile device according to an embodiment of the invention comprises: a main body with a guiding means; a movable body installed movably along the guiding means; and an elasticity module according to the invention, which is installed between the main body and the movable body and pushes the movable body in at least one direction of the guiding means in at least a part of the zone when the movable body moves along the guiding means. In certain embodiments, the elasticity module may comprise a first spring arm, a second spring arm and a spring connected to each of the first spring arm and the second spring arm rotatably and installed so as to change a direction of elastic force according to the rotating angle of the spring, and the first spring arm is connected to the main body rotatably, and the second spring arm is connected to the movable body rotatably.

In the mobile devices, until the movable body moves along the guiding means and opens from a closed state, or until the movable body opens upward from a closed state after opened downward initially, the elasticity module may comprise a first zone in which a distance between connectors on both ends decreases and a second zone in which the distance increases, and the spring may be installed so as to alternatingly change directions of the elastic force on the second spring arm through a rotational operation during each the first zone and the second zone, being configured to open in two steps or upwardly and downwardly.

A slide opening/closing apparatus according to the invention may comprise an elasticity module using magnets according to the invention, which comprises: a guiding member having a guiding means; a sliding member combined to the guiding means and installed so as to move; and an elasticity module disposed between the guiding member and the sliding member, configured to push the sliding member in at least one direction of the guiding means in at least part of zone when the sliding member moves along the guiding means, and until the sliding member moves along the guiding means and opens from a closed state, or until the sliding member opens upward from a closed state after opened downward initially, the elasticity module may comprise a first zone in which a distance between connectors on both ends decreases and a second zone in which the distance increases, and the first magnet arm may be installed so as to alternatingly change directions of the magnetic force on the second magnet arm through a translational operation during each the first zone and the second zone, being configured to open in two steps or upwardly and downwardly.

A mobile device according to an embodiment of the invention comprises: a main body with a guiding means; a movable body installed movably along the guiding means; and an elasticity module using magnets according to the invention, in which the first magnet arm is connected to the main body rotatably, and the second magnet arm is connected to the movable body rotatably, and until the movable body moves along the guiding means and opens from a closed state, or until the movable body opens upward from a closed state after opened downward initially, the elasticity module may comprise a first zone in which a distance between connectors on both ends decreases and a second zone in which the distance increases, and the first magnet arm may be installed so as to alternatingly change directions of the magnetic force on the second magnet arm through a translational operation during each the first zone and the second zone, being configured to open in two steps or upwardly and downwardly.

The mobile devices in the invention may be called mobile electronic devices.

### Advantageous Effects

According to the invention, the size of spring can be reduced compared to the traditional spring, and various types of spring can be used.

And, an operation range is larger for a size of the spring, it is easy to adjust the magnitude of the elasticity, and it enables to adjust the magnitude of the elasticity for a same size.

Even though using a torsion spring, an elastic force acting in a linear direction can be obtained, and it is stable in operation and tough against a vertical force.

Even with a torsion spring with arms, the arms do not protrude outwardly.

When a twist force of up-down direction is produced in a spring, it is subdued by a first spring arm and a second spring arm.

An elasticity module according to the invention can be designed adjusting a direction of an elastic force of a spring.

Also, the invention provides mobile devices enabling two step or vertical opening of a movable body.

### BRIEF DESCRIPTION OF DRAWINGS

FIG. 1 is a perspective disassembled view of a elasticity module according to an embodiment of the invention,

FIG. 2 is a perspective view of the elasticity module in FIG. 1,

FIG. 3 is a perspective view showing a second spring arm moved half-way,

FIG. 4 is a perspective view showing the second spring arm moved all the way to the other side,

FIG. 5 is a perspective disassembled view showing a variation of the elasticity module in FIG. 1,

FIG. 6 is a perspective view of the elasticity module in FIG. 5,

FIG. 7 is a perspective view showing a state where the second spring arm is moved to the other side,

FIG. 8 is a perspective disassembled view showing another variation of FIG. 1,

FIG. 9 is a perspective view showing still another variation of the elasticity module in FIG. 1,

FIG. 10 is a perspective view showing still another variation of the elasticity module in FIG. 1,

FIG. 11 is a perspective view showing an elasticity module according to another embodiment of the invention,

FIG. 12 is a perspective disassembled view of the elasticity module in FIG. 11,

FIG. 13 is a perspective view showing a variation of FIG. 11,

FIG. 14 is a perspective disassembled view of the elasticity module of FIG. 13,

FIG. 15 is a perspective view showing another variation of FIG. 11,

FIG. 16 is a perspective disassembled view of the elasticity module of FIG. 15,

FIG. 17 is a perspective disassembled view showing still another embodiment of an elasticity module according to the invention,

FIG. 18 is a perspective disassembled view of a variation of FIG. 15,

FIG. 19 is a perspective disassembled view of a variation of an elasticity module shown in FIG. 17,

FIG. 20 is a perspective disassembled view an elasticity module according to another embodiment of the invention,

FIGS. 21 and 22 are perspective views showing other variations of FIG. 15,

FIG. 23 is a perspective view showing an elasticity module according to another embodiment of the invention,

FIG. 24 is a perspective view showing an elasticity module according to another embodiment of the invention,

FIGS. 25 and 26 are perspective views showing elasticity modules according to other embodiments of the invention respectively,

FIG. 27 is a perspective disassembled view of mobile device using an elasticity module according to the invention,

FIG. 28 is a plan view showing layout plan of elements of the mobile device in an assembled state,

FIG. 29 is a plan view showing a state of a second body of FIG. 28 which is half-opened,

FIG. 30 is a plan view showing a state of the second body of FIG. 28 which is opened completely,

FIGS. 31-33 are plan view showing operations of elasticity module according to another embodiment,

FIG. 34 is a perspective disassembled view showing an elasticity module according to still another embodiment of the invention,

FIG. 35 is a perspective disassembled view showing another embodiment of the invention,

FIGS. 36 and 37 are perspective disassembled views showing variations of FIG. 35,

FIG. 38 is a perspective view showing a spring and magnet complex elasticity module, and

FIG. 39 is a perspective view showing a state where the second magnet arm in FIG. 38 is moved to the left.

### BEST MODE FOR CARRYING OUT THE INVENTION

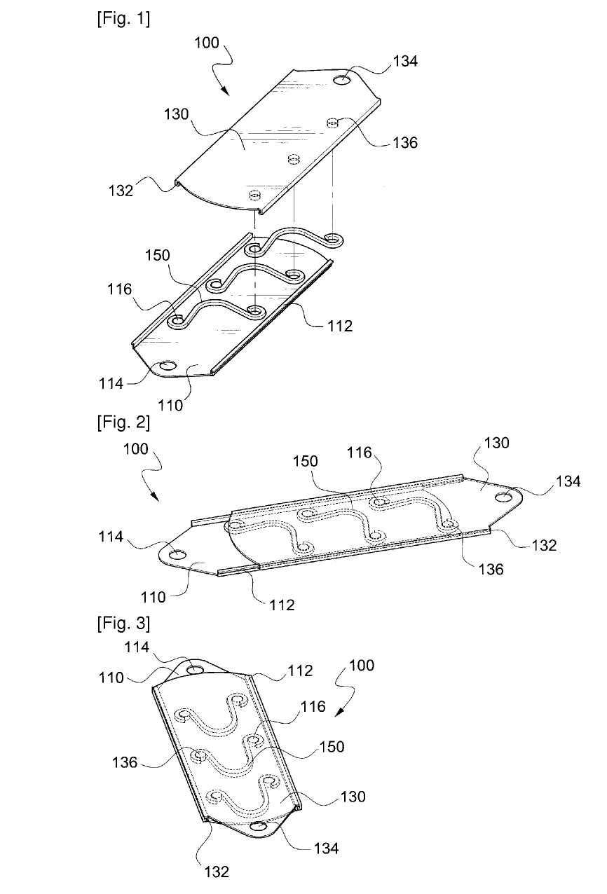

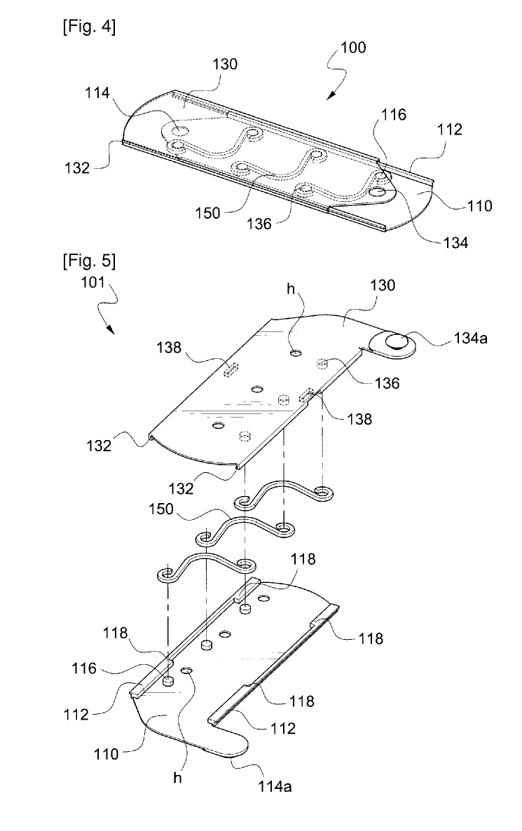

Embodiments of the invention are described in detail below referring to the drawings. FIG. 1 is a perspective disassembled view of a elasticity module according to an embodiment of the invention, FIG. 2 a perspective view of the elasticity module in FIG. 1, FIG. 3 a perspective view showing a second spring arm moved half-way, and FIG. 4 a perspective view showing the second spring arm moved all the way to the other side.

As shown in FIGS. 1-4, an elasticity module (100) according to the invention comprises a first spring arm (110) having a guiding portion (112). This first spring arm (110) may be made by pressing metal plate. Alternatively, the first spring arm (110) can be made by molding with plastic. The guiding portion (112) is disposed along edges of both sides of the first spring arm (110), and the edges of both sides of the first spring arm (110) are bent upward, and then parts of them are bent again outward. A first connecting hole (114) for connecting to other member is provided around a left end of the first spring arm (110). In certain embodiment in which a rotational axle is installed in the other member to which the first spring arm (110) is connected and the connection is made by spot welding or melting, the first connecting hole (114) may not be needed. In such first spring arm (110), a first protrusion (116) for spring connection is provided. The number of the first protrusion (116) for spring connection depends on the number of springs, and therefore can be variable. One or more first protrusion (116) can be installed with intervals.

The first protrusion (116) for spring connection may be installed permanently. In such an embodiment, the springs (150) are connected to the first protrusion (116). In a certain embodiment, the first protrusion (116) may be installed as a rotational axle. In this case, the spring (150) may be connected to the first protrusion (116) permanently.

Since in certain embodiments a hole is formed on a bottom of the first spring arm (110) and the an end of the spring (150) is bent toward the bottom surface of the first spring arm (110), then connected to the hole, the first protrusion (116) for spring connection does not have to be formed.

An elasticity module (100) according to the invention comprises a second spring arm (130) in which a guided portion (132) that is connected to the guiding portion (112) and movable along the guiding portion (112) is formed. The guided portion (132) is also disposed along edges of both sides of the second spring arm (130), and both sides are bent downward toward the first spring arm (110) and parts of them are bent again inward. A second connection hole (134) is formed on a right end of the second spring arm (130) for connecting to other member. The second connection hole (134) is also not necessary always. The second spring arm (130) may be also made by machine manufacturing such as press or molding. Preferably, along one inside edge of the second spring arm (130) the second protrusion (136) for spring connection to which the other end of the spring (150) is connected must be installed with intervals. A description of the second protrusion (136) for connection installed in the second spring arm (130) is much like that of the first protrusion (116) formed in the first spring arm (110).

As described in the above, in a state that the first spring arm (110) and the second spring arm (130) are connected, there is a gap space between the first spring arm (110) and the second spring arm (130) where the spring (150) can be disposed.

An elasticity module (100) according to the invention may comprise a spring (150) having a spring wire which is curved in a circular shape. One end of the spring (150) is connected to the first protrusion (116) for spring connection of the first spring arm (110), and the other end is connected to the second protrusion (136) for spring connection of the second spring arm (130).

The number of the spring (150) may be determined according to desired magnitude of elasticity. In the embodiments of FIGS. 1-4, three springs (150) are used. The spring (150) has a general shape of a bow. The spring (150) shown in FIGS. 1-4 has a very simple structure, which is easy to make and uses little of material for spring wire.

In this embodiment, the first and second connection holes (114, 134) are a connection portion for connecting to other members. And the first spring arm (110) and the second spring arm (130) can swap their roles in another structure. In this case, a guiding portion becomes a guided portion, and a guided portion becomes a guiding portion. The same can be applied to the embodiments shown below.

That is, firstly, the first spring arm (110) and the second spring arm (130) shown in FIG. 1 are assembled as shown in FIG. 2, and then, if moves the second spring arm (130) to the left against the first spring arm (110) with an external force, the spring (150) rotates with the translational movement of the second spring arm (130) against first spring arm (110), distance between two ends connected to the first spring arm (110) and the second spring arm (130) decreases, and if the distance is reduced to the least, and then even with the external force removed the second spring arm (130) moves to the state shown in FIG. 4 automatically by the recovering force of the spring (150). The operation for returning the second spring arm (130) to the original position is same as the above operation in a reverse order.

Of course, if the first spring arm (110) and the second spring arm (130) are pulled apart in opposite directions in FIG. 2, the elasticity module (100) can be extended more, and exerts elastic force in a direction of contraction in the extended state. If a force is applied in a direction that the two connecting portions (114, 134) get closer, the spring (150) may be extended more, and the spring (150) exerts elastic force in a direction that the two connecting portions (114, 134) get apart more. In certain embodiments, these operations may be used in a device where the elasticity module (100) is installed.

The first spring arm (110) and the second spring arm (130) connected to each other slidingly as described in the above are called a spring arm portion in this specification. The same is true for first and second spring arms described below.

### MODE FOR THE INVENTION

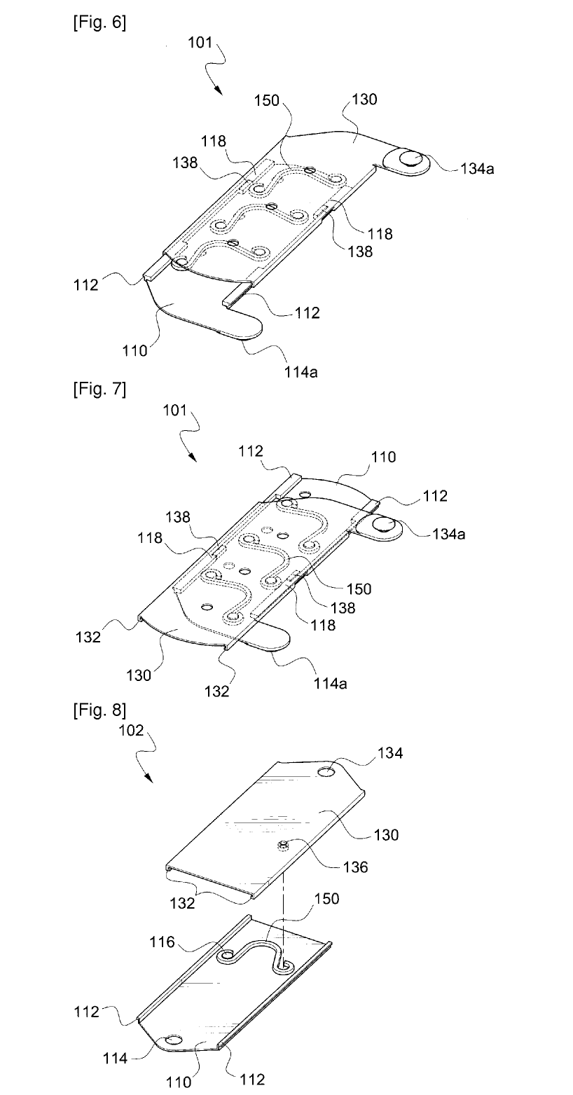

FIG. 5 is a perspective disassembled view showing a variation of the elasticity module in FIG. 1, FIG. 6 a perspective view of the elasticity module in FIG. 5, and FIG. 7 a perspective view showing a state where the second spring arm is moved to the other side.

In an elasticity module (101) shown in FIG. 5, the spring (150) and the first and second protrusions (116, 136) for spring connection are same as described for FIGS. 1-4. The differences against the previous embodiments are as follows. As illustrated, a first connecting portion (114a) for connecting to other member is formed, in one end of the first spring arm (110), protruding sideways off from between the guiding portions (112) on both sides around one side end of the first spring arm (110). Similarly, a second connecting portion (134a) for connecting to other member on the second spring arm (130) is formed protruding sideways off from between the guided portions (132) on both sides. In FIGS. 5-7, the first connecting portion (114a) and the second connecting portion (134a) protrude in the same direction, but they can be formed to protrude in opposite directions.

As shown, a stopper (118) for limiting moving distance of the second spring arm (130) is formed in the first spring arm (110), a latch (138) to be hooked to the stopper (118) when the second spring arm (130) moves for a predetermined distance is formed at a corresponding location of the second spring arm (130).

In certain embodiments, a plurality of holes (h) can be formed in the first spring arm (110) and the second spring arm (130) so as to use for reducing weight, connecting with other member, observing inside, etc.

The operation of the elasticity module (101) in FIGS. 5-7 is same as in the previous embodiments, except that the moving range of the second spring arm (130) against the first spring arm (110) by the stopper (118) and the latch (138) and the connecting portion are different.

FIG. 8 is a perspective disassembled view showing another variation of FIG. 1.

In certain embodiments, an elasticity module (102) can be embodied by installing the spring (150) having a portion of a circular shape between the first spring arm (110) and the second spring arm (130). And the position of the first protrusion (116) connected to the spring (150) in the first spring arm (110) and the position of the second protrusion (136) connected to the spring (150) in the second spring arm (130) may be adjusted according to the designed positions of the first spring arm (110) and the second spring arm (130) before and after the operation. Others were described in relation to FIGS. 1-4.

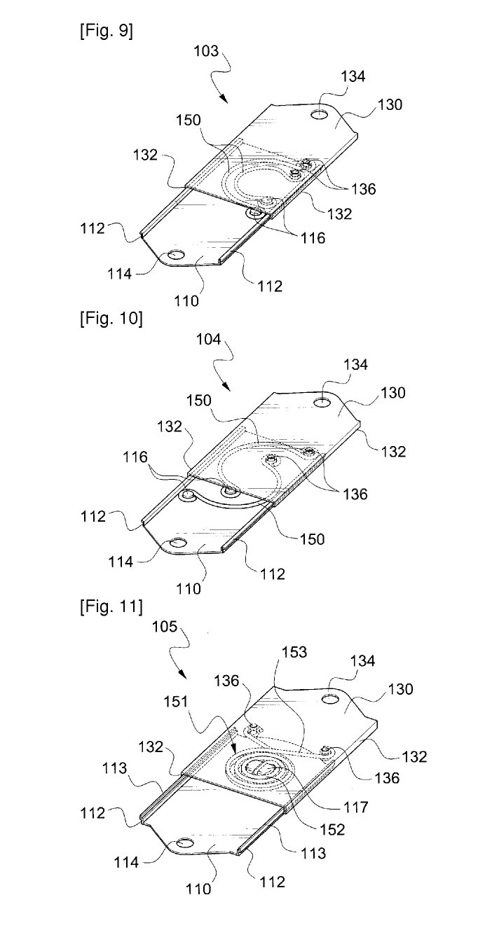

FIG. 9 is a perspective view showing still another variation of the elasticity module in FIG. 1.

When the moving distances of the first spring arm (110) and the second spring arm (130) may be small, the first protrusion (116) for spring connection formed in the first spring arm (110) and the second protrusion (136) for spring connection formed in the second spring arm (130) can be disposed along a line, where the spring (150) having portion of a circular shape can be of different sizes. In the elasticity module (103), the guiding portion (112), the guided portion (132), the connecting holes (114, 134) for connecting to other member, etc. are same as described before. Instead of the connecting holes (114, 134), protrusions or rotational axles may be installed.

FIG. 10 is a perspective view showing still another variation of the elasticity module in FIG. 1.

In certain embodiments, two springs (150) may be disposed alternatingly in tilted direction along a direction of length of the first spring arm (110) and the second spring arm (130) in order to make an elasticity module (104) according to the invention. Except for the number of the springs (150), disposition of the springs (150) and disposition of the protrusions (116, 136) for spring connection, the guiding portion (112), the guided portion (132), etc. are same as described in relation to FIGS. 1-4.

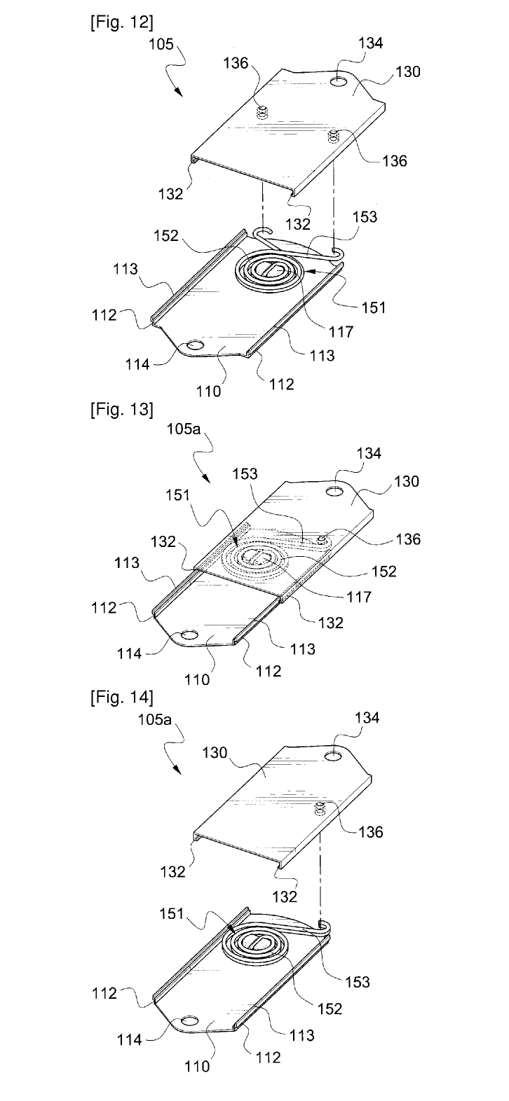

FIG. 11 is a perspective view showing an elasticity module according to another embodiment of the invention, and FIG. 12 a perspective disassembled view of the elasticity module in FIG. 11.

As shown in FIGS. 11 and 12, in certain embodiments, a first protrusion (117) for spring connection may be formed at one side of the first spring arm (110). The first protrusion (117) for spring connection may be formed by pressing the first spring arm (110) toward the second spring arm (130) leaving a gap to which an end of the torsion spring (151) can be inserted. Two second protrusions (117) for spring connection are formed on the second spring arm (130) with an intervalin the left-right direction.

Since in this case the interval between the first spring arm (110) and the second spring arm (130) must be larger than a case when the spring (151) is installed alone, a gap-keeping portion (113) is formed above the guiding portion (112), and the guided portion (132) must be formed relatively higher.

In this embodiment, the torsion spring (151) is installed as a spring installed between the first spring arm (110) and the second spring arm (130). This torsion spring (151) comprises a winding portion (152) wound without overlapping and an extending arm (153) extended from an outer end of the winding portion (152) toward the outside of the winding portion (152). This torsion spring (151) is installed such that one of two of those is put on the top of the other, an inner end of the winding portion (152) is overlapped and connected to the first protrusion (117) of the first spring arm (110), and the end of the extending arm (153) of the two torsion springs (151) are connected to the two second protrusions (136) respectively.

When an elasticity module (105) is made as shown in FIGS. 11 and 12, the second spring arm (130) receives an elastic force in one direction only against the first spring arm (110) in almost all moving range.

FIG. 13 is a perspective view showing a variation of FIG. 11, and FIG. 14 a perspective disassembled view of the elasticity module of FIG. 13.

The elasticity module (105a) in this embodiment, not like in FIG. 11, comprises one second protrusion (136) for spring connection formed in the second spring arm (130), such that extending arms (153) for spring connection of two torsion springs (151) are overlapped and connected to the one second protrusion (136). Other aspects are same as in FIGS. 11 and 12.

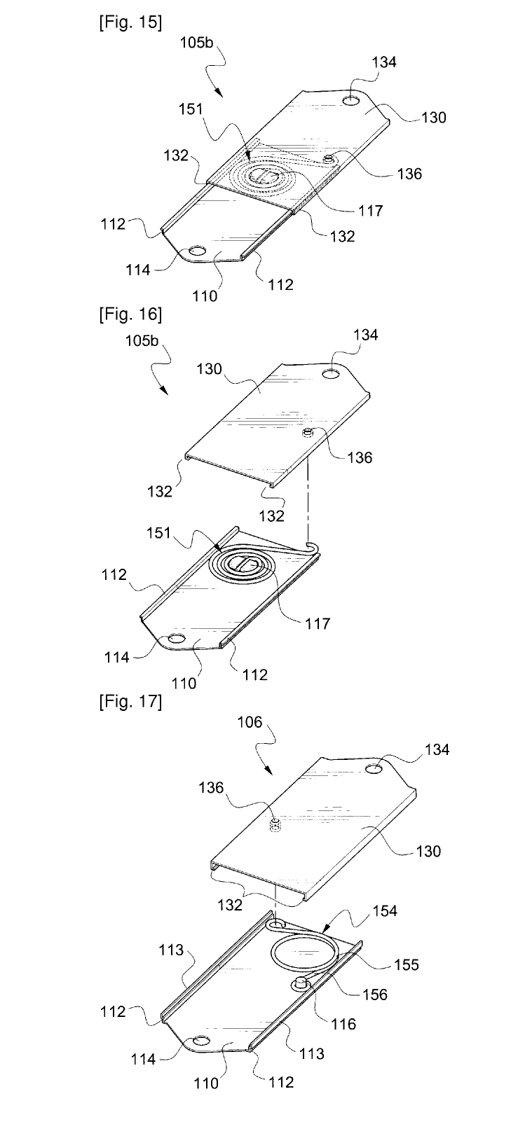

FIG. 15 is a perspective view showing another variation of FIG. 11, and FIG. 16 a perspective disassembled view of the elasticity module of FIG. 15.

In certain embodiments, the interval between the first spring arm (110) and the second spring arm (130) in FIG. 15 may be small, and one torsion spring (151) may be installed such that the first protrusion (117) and the second protrusion (136) are formed low, making an elasticity module (105b) according to the invention. Other aspects are same as in FIGS. 13 and 14.

FIG. 17 is a perspective disassembled view showing still another embodiment of an elasticity module according to the invention.

If the thickness may be thick a little, a torsion spring (154) comprising a winding portion (155) wound with overlapped portions and an extending arm (156) extended from the winding portion (155) to both sides may be connected to the first protrusion (116) and the second protrusion (136) of the first spring arm (110) and the second spring arm (130) rotatably, to make an elasticity module (106) according to the invention.

Descriptions of the guided portion (132), the guiding portion (112), etc. are same as those in regarding to FIGS. 11 and 12.

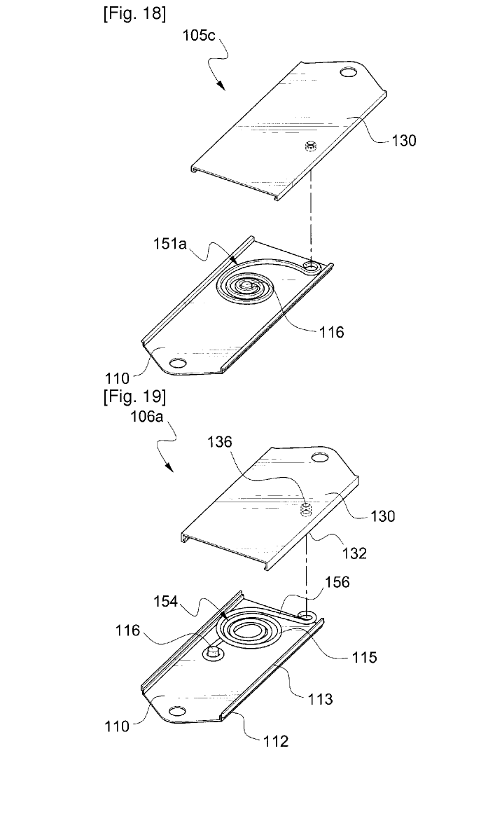

FIG. 18 is a perspective disassembled view of a variation of FIG. 15.

In a certain embodiment, a torsion spring (151a) made of spring wire having rectangular cross-section instead of circular, and the first protrusion (116) having no gap may be used to make elasticity module (105c). Other aspects are same as in FIG. 15.

FIG. 19 is a perspective disassembled view of a variation of an elasticity module shown in FIG. 17.

As shown in FIG. 19, an elasticity module (106a) may be made using a torsion spring (154) with a winding portion (155) having two or more windings. Except for the installation direction of the spring (154) and the disposed position of the first protrusion (116) and the second protrusion (136), others are same as in FIG. 17.

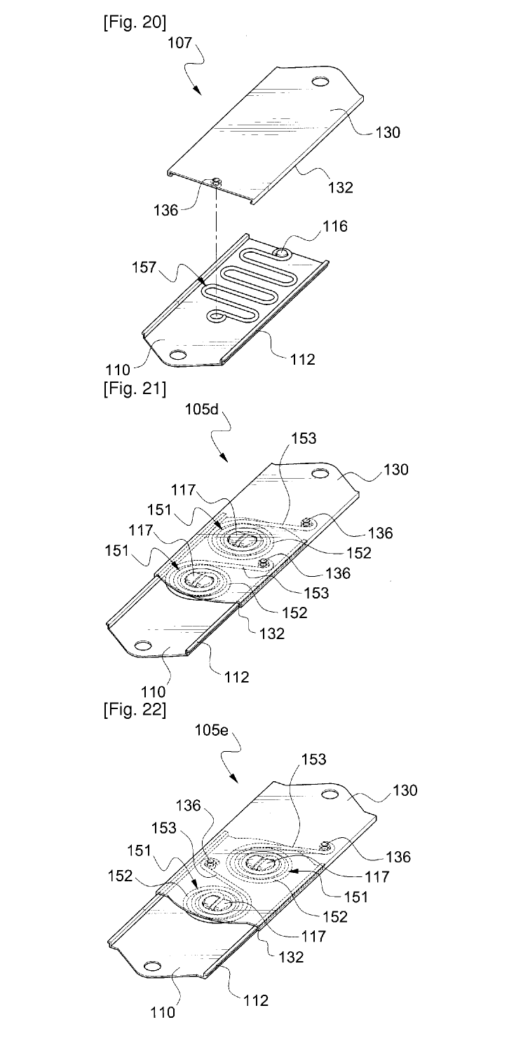

FIG. 20 is a perspective disassembled view an elasticity module according to another embodiment of the invention.

As shown in FIG. 20, an elasticity module (107) may be made by installing a spring (157) formed by spring wire bent to the left and right alternatingly which is installed between the first spring arm (110) and the second spring arm (130). Below, the spring (157) shown in FIG. 20 is called a wave-type spring.

The guiding portion (112) and the guided portion (132) are same as described in FIG. 3, and the first protrusion (116) and the second protrusion (136) are installed at a central portion in a direction of width around one ends of the first spring arm (110) and the second spring arm (130) respectively.

In case of using a spring (157) as shown in FIG. 20, there may be a zone where an elastic force of the spring (157) according to moving position of the second spring arm (130) against the first spring arm (110) exerts in a first direction, a zone where the elastic force exerts in a second direction, and a zone where the elastic force does not exert in any direction and lies between the above two zones.

FIGS. 21 and 22 are perspective views showing other variations of FIG. 15.

As shown in FIG. 21, an elasticity module (105d) may be made by forming two first protrusion(117), to which one end of the spring (151) can be inserted and fixed, in the first spring arm (110) on a thin plate, and forming the second protrusion (136) which connects the extending arm (153) of the two spring (151) rotatably with an interval along an edge of one side in the second spring arm (130), so as to install the extending arm (153) of the spring (151) in a same direction.

In a certain embodiments, the second protrusion (136) for spring connection installed in the second spring arm (130) is installed on edges of both sides respectively, and the extending arm (153) of the spring (151) is disposed facing different directions, in order to make an elasticity module (105e) according to the invention. In this case, the second spring arm (130) receives elastic force against the first spring arm (110) in a direction only in almost all of its operation zone.

The guiding portion (112), the guided portion (132), etc. are same as described in FIG. 15.

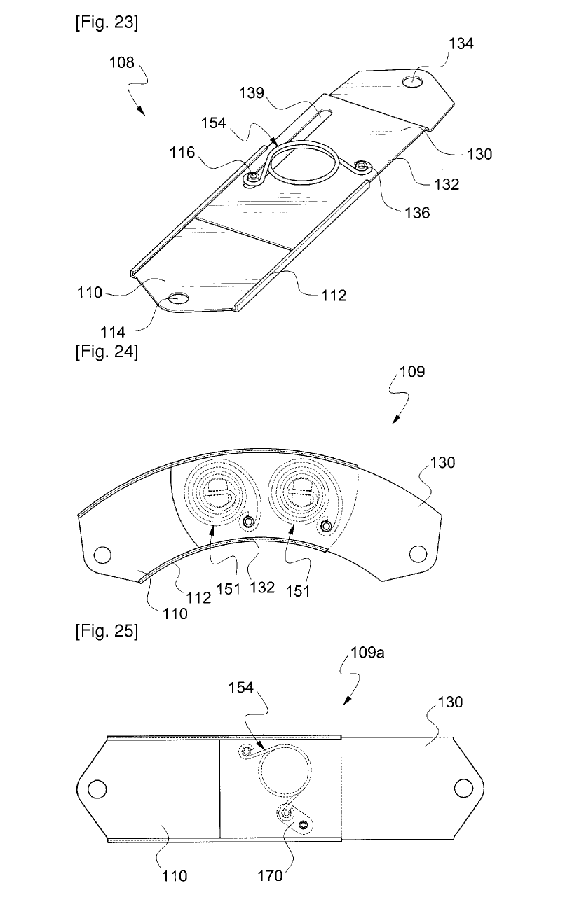

FIG. 23 is a perspective view showing an elasticity module according to another embodiment of the invention.

All the springs were disposed between the first and second spring arms in the previous embodiments, but in certain embodiments an oblong hole (139) may be formed in the second spring arm (130), and the spring (154) may be installed above the second spring arm (130). In this case, the second protrusion (136) for spring connection installed in the second spring arm (130) may be formed on a top surface of the second spring arm (130). The first protrusion (116) installed in the first spring arm (110) may protrude through the oblong hole (139) toward the second spring arm (130), to which one end of the spring (154) is connected and the movement of the second spring arm (130) is not hindered. This structure applies to the previous embodiments.

Also, the second spring arm (130) may be formed such that one side is bent downward. As long as the guided portion (132) is connected to and moved with the guiding portion (112), the guiding portion (112) and the guided portion (132) can be transformed into other forms.

FIG. 24 is a perspective view showing an elasticity module according to another embodiment of the invention.

In certain embodiments, an elasticity module (109) may be made by forming the first spring arm (110) and the second spring arm (130) in curved forms. Of course, in this case the guiding portion (112) must be formed in curved form. The guided portion (132) is preferably formed in curved form.

Also, the first spring arm (110) and the second spring arm (130) may be formed in linear forms, and only the guiding portion (112) and the guided portion (132) may be formed along curved path.

Other connection styles of the spring (151) are same as described in the previous embodiments.

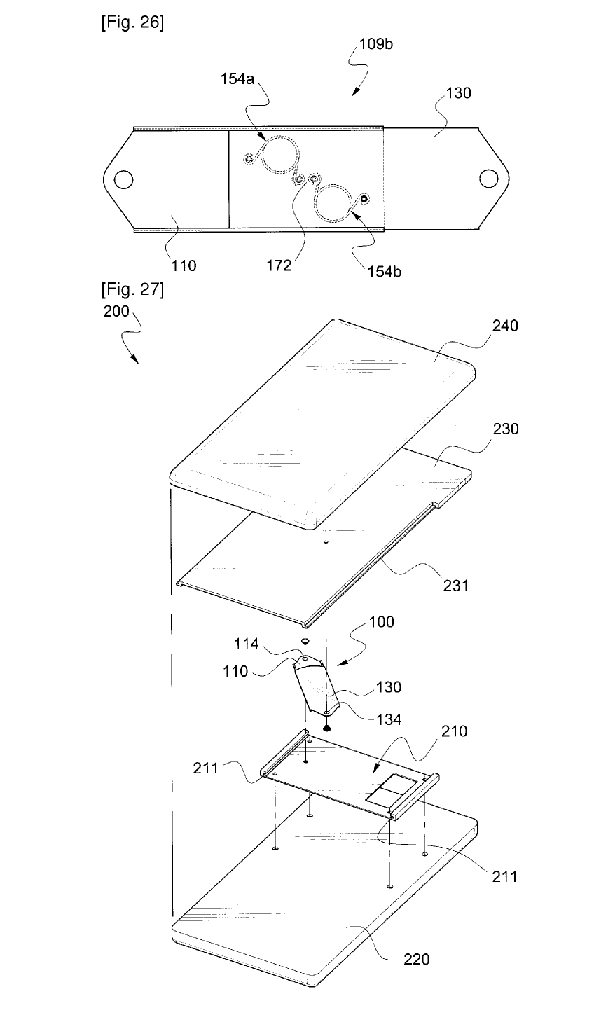

FIGS. 25 and 26 are perspective views showing elasticity modules according to other embodiments of the invention respectively.

In certain embodiments, as shown in FIG. 25, an elasticity module (109a) may be made by connecting one end of the spring (154) to the first spring arm (110), connecting one end of the rotating member (170) to the second spring arm (130), connecting the other end of the spring (154) with the other end of the rotating member (170). In another embodiment, as shown in FIG. 26, an elasticity module (109b) may be made by connecting one end of the first spring (154a) to the first spring arm (110), connecting one end of the second spring to the second spring arm (130), and connecting two other ends of the springs (154a, 154b) to the connecting member (172). By these, operating types of the elastic force exerting in a direction of the guiding portion (112) may be varied according to the installing position of the rotating member (170) and the connecting angle of the connecting member (172).

Other structures such as the guiding portion (112), the guided portion (132), etc. are same as described in the previous embodiments.

In a certain embodiment, two or more elasticity modules described in the above may be connected and fixed to each other linearly or bent with a predetermined angle through the first spring arm or the second spring arm, in order to make a complex elasticity module, and furthermore two or more elasticity modules may be connected to each other rotatably by a predetermined angle through the first spring arm or the second spring arm, in order to make another complex elasticity module.

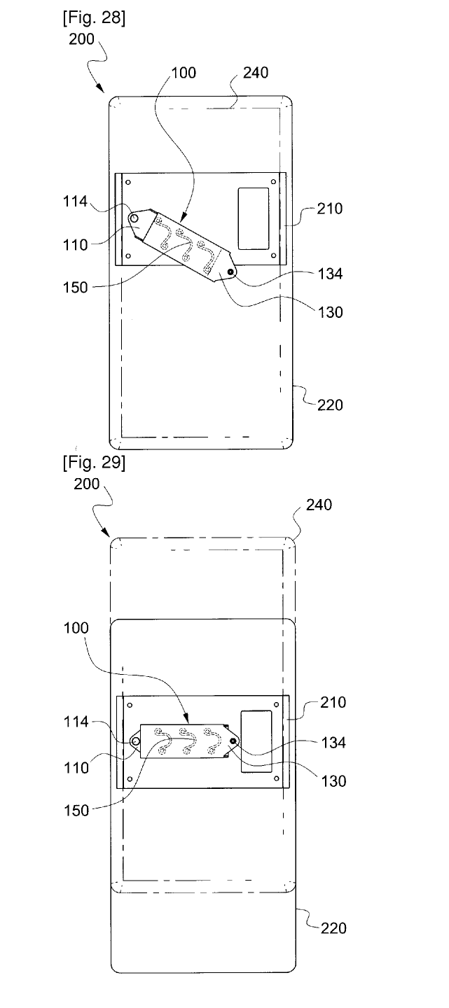

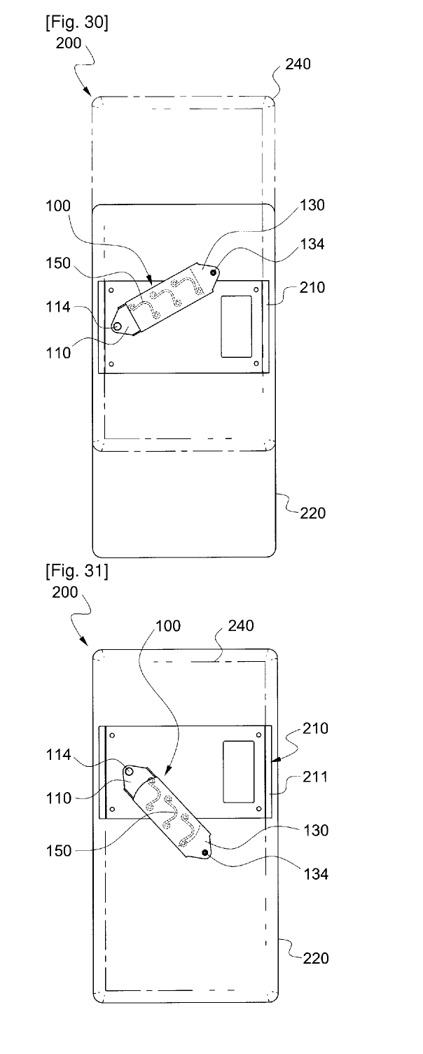

FIG. 27 is a perspective disassembled view of mobile device using an elasticity module according to the invention, FIG. 28 a plan view showing layout plan of elements of the mobile device in an assembled state, FIG. 29 a plan view showing a state of a second body of FIG. 28 which is half-opened, and FIG. 30 a plan view showing a state of the second body of FIG. 28 which is opened completely.

In FIG. 27, a guiding member (210) is shown. Guiding means (211) are disposed along edges on both sides of the guiding member (210). In this embodiment, the guiding means (211) is formed as a groove, but other things such as a shaft with a circular cross-section, for example, may be used. Such guiding means (211) of the guiding member (210) may be formed integrally as one body with a main body (220) of the mobile device (200) in certain embodiments.

A sliding member (230) is shown above the guiding member (210). This sliding member (230), connected to the guiding means (211) movably through a guiding bump (231) which is formed in a line, is connected to a movable body (240) shown in the above in the figure. In a certain embodiment, without the sliding member (230), only the guiding bump (231) may be formed integrally as one body with the movable body (240).

As illustrated, an elasticity module (100) according to the invention is shown between the guiding member (210) and the sliding member (230). The first spring arm (110) of the elasticity module (100) is connected to the guiding member (210) rotatably through the first connecting hole (114), the second spring arm (130) is connected to the sliding member (230) rotatably through the second connection hole (134).

The guiding member (210), the sliding member (230), and the elasticity module (100) installed between them may be assembled to make a slide opening/closing apparatus for mobile phone, game machine, PDA, PMP, etc. for the market.

Referring FIGS. 28-30, the operation of the mobile device (200) having the above elements assembled will be described in detail below.

Before starting to describe the operations, it should be notified that the tilting angle of the elasticity module (100) in an initialized state shown in FIG. 28 is installed to be small, such that the direction of elastic force of the spring (150) does not change when the distance between the first connecting hole (114) and the second connection hole (134) becomes a minimum. If the tilting angle of the elasticity module (100) in an initialized state is selected to be small, the moving distance of the second spring arm (130) until the distance between the first connecting hole (114) and the second connection hole (134) becomes the minimum is reduced relatively.

If exerting a force at the movable body (240) upward holding the mobile device (200) as shown in FIG. 28, the movable body (240) and the sliding member (230) installed below it move upward riding the guiding means (211). By this, the first spring arm (110) in the elasticity module (100) rotates counterclockwise about the first connecting hole (114) connected to the guiding member (210), and the second spring arm (130) of the elasticity module (100) moves toward the first connecting hole (114), then up to the position shown in FIG. 29 where the distance between the first connecting hole (114) and the second connection hole (134) becomes a minimum. Of course, the spring (150) of the elasticity module (100) in this zone exerts elastic force in a direction so as to hinder the second spring arm (130) from moving toward the first connecting hole (114).

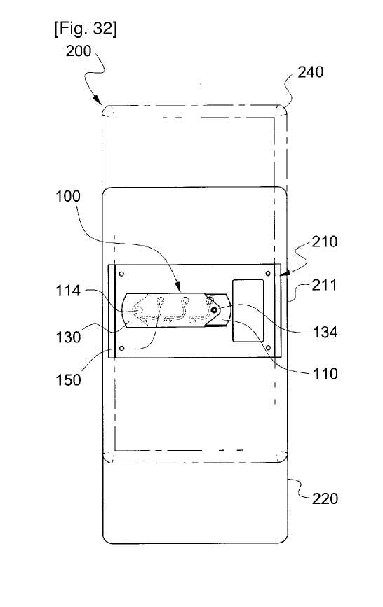

After the second spring arm (130) moves to the position shown in FIG. 29 where the distance between the first connecting hole (114) and the second connection hole (134) becomes a minimum, the second spring arm (130) moves in a direction such that the distance between the first connecting hole (114) and the second connection hole (134) increases, by the elastic force of the spring (150), even with the external force removed, and finally the movable body (240) moves all the way upward to be opened as shown in FIG. 32. The procedure for closing the movable body (240) is same as the procedures for opening in reverse order.

FIGS. 31-33 are plan view showing operations of elasticity module according to another embodiment.

If installed with larger tilting angle of the elasticity module (100) as shown in FIG. 31, not like in FIGS. 28-30, opening/closing operation in two steps is possible.

That is, if exerting a force at the movable body (240) upward holding the mobile device (200) of a state in FIG. 31, the movable body (240) moves upward riding the guiding means (211), the elasticity module (100) rotates about the first connecting hole (114), and then the second spring arm (130) of the elasticity module (100) moves toward the first connecting hole (114). In a middle of the operation before the elasticity module (100) starting at a state in FIG. 31 becomes a state in FIG. 32, the spring (150) rotates and changes the direction of the elastic force. Afterwards, even with the external force removed, first step of opening is achieved to the state shown in FIG. 32 by the elastic force of the spring (150).

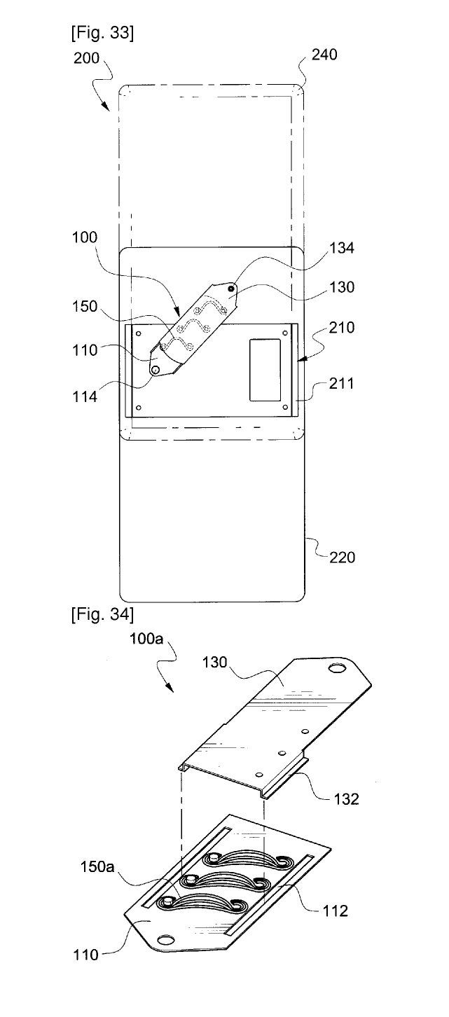

If exerting a force at the movable body (240) upward in a state of FIG. 32, the second spring arm (130) of the elasticity module (100) moves in a direction opposite to the initial direction, the springs (15) rotate in a direction opposite to the initial direction, and even if removing the external force after the position where the direction of elastic force was changed, second step of opening to the state in FIG. 33 is achieved by the elastic force of the spring (150).

And when the movable body (240) is closed onto the main body (220) for the state of FIG. 32, if the movable body (240) is opened downward as in FIG. 31 or upward as in FIG. 33, that is, the elasticity module (100) according to the invention is used, the movable body (240) may be configured to open pretty easily in both directions, upward or downward. The operation of the elasticity module (100) from a state opened downward through a closed state to a state opened upward is same as the two-step opening procedure in the above.

The operation to close the movable body (240) includes the procedures for opening the movable body (240) in reverse order.

That is, if adopting the elasticity module according to the invention, one-step and two-step openings of the movable body or sliding member can be achieved selectively according to the installation angle.

Also, in a certain embodiment, opening in both directions, upward and downward, of the sliding member can be achieved easily.

FIG. 34 is a perspective disassembled view showing an elasticity module according to still another embodiment of the invention.

As illustrated, in certain embodiments, an elasticity module (100) may be made by forming a guiding portion (112) of an oblong shape along both sides of the first spring arm (110) and a guided portion (132) which is inserted in the guiding portion (112) and guided along both sides of the second spring arm (130).

Also, the spring may comprise a spring (150a) made by combining a plurality of bow-type springs. With this type of spring, it is possible to obtain an elasticity module (100a) having a large elastic force. Other aspects are same as described in regarding to FIG. 1.

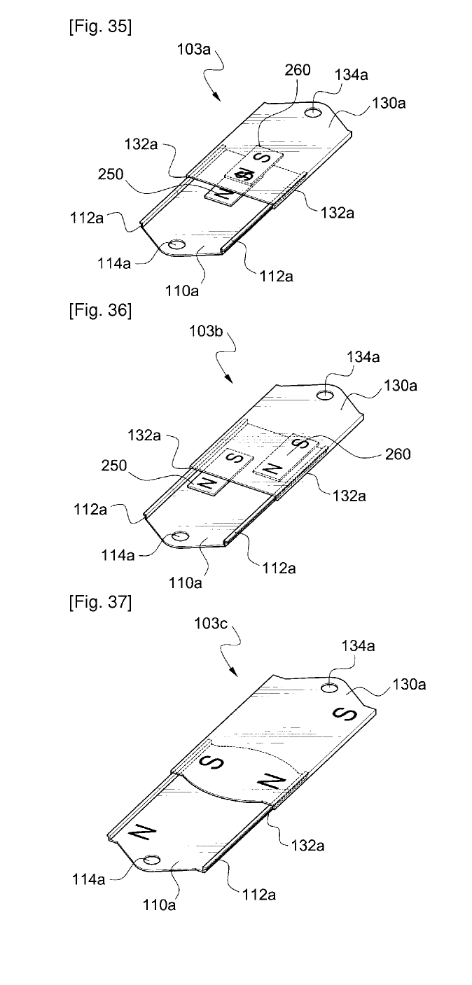

FIG. 35 is a perspective disassembled view showing another embodiment of the invention, FIGS. 36 and 37 perspective disassembled views showing variations of FIG. 35.

In certain embodiments, instead of the spring arms in the previous embodiments, elasticity modules (103a, 103b) according to the invention can be made by connecting a first magnet arm (110a) and the second magnet arm (130a) with a guiding portion (112a) and a guided portion (132a) slidingly. Here, it is probable to dispose a first magnet (250) and a second magnet (260) on the first magnet arm (110a) and the second magnet arm (130a) at positions where repelling or attracting forces can be exerted to each other as shown in FIG. 35 or FIG. 36, so as to exert attracting or repelling force in a direction of the guiding portion (112a) according to the translational position of the second magnet arm (130a) against the first magnet arm (110a). The disposition of the magnetic poles of the first magnet (250) and the second magnet (260) may be done according to usage of the elasticity module (103a, 103b) or installation environment of the elasticity module (103a), or so as to exert attracting force in an initialized state or repelling force, or so as to be in a stable state where the N-pole of the first magnet (250) is disposed close to the S-pole of the second magnet (260). It is preferable to form connecting portion (114a, 134a) on the first magnet arm (110a) and the second magnet arm (130a).

The shape, number, and location of magnets may be varied.

In certain embodiments, as shown in FIG. 37, the first magnet arm (110a) and the second magnet arm (130a) may be magnetized to make an elasticity module (103c) according to the invention.

The embodiment in FIGS. 35 and 36 and the embodiment in FIG. 37 may also be combined.

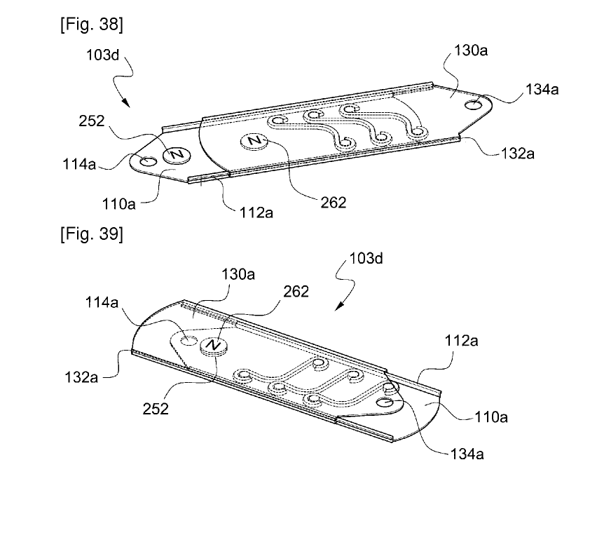

FIG. 38 is a perspective view showing a spring and magnet complex elasticity module, and FIG. 39 is a perspective view showing a state where the second magnet arm in FIG. 38 is moved to the left.

As illustrated, the first magnet arm (110a) and the second magnet arm (130a) of the elasticity module (103d) may be in a state being held in a position by connecting the spring (150) to the two magnet arms between the first magnet arm (110a) and the second magnet arm (130a) rotatably, installing a first magnet (252) at one side of the first magnet arm (110a) and a second magnet (262) at one side of the second magnet arm (130a), and disposing the first magnet (252) and the second magnet (262) so as to exert attracting force by opposing opposite magnetic poles when the elasticity module (103d) is contracted fully as shown in FIG. 39. Other aspects are same as described in regarding to FIGS. 2 and 4.

In the present invention, in addition to the springs described in the previous embodiments, anything which can provide elastic force between the two members can be used, including coil spring or various types of springs, and anything which has a latching zone enabling sliding motion can vary the guiding portion and the guided portion, all of which belong to the present invention.

### INDUSTRIAL APPLICABILITY

The present invention is suitable for mobile devices using slide opening/closing mechanism such as wireless phone, PDA, PMP, portable game machine, electronic scheduler, etc.

The elasticity module according to the present invention may be used for a spring in all the industries using springs.

The elasticity module may be used as a linking element having a flexible length.

1. An elasticity module comprising:
a spring arm portion comprising first and second spring arms combined so as to have a sliding zone in which at least parts of them latch each other slidingly in an overlapped position; and
a spring disposed between the first and second spring arms for applying elasticity to in-between the first and second spring arms by an elastic deformation through the first spring arms translation against the second spring arm over at least a part of the sliding zone.

2. The elasticity module of claim 1, wherein the spring comprise:
one, two, or more selected from a group of: a torsion spring comprising a winding portion which is wound spirally;
a torsion spring comprising a winding portion wound spirally and an extending arm extended outwardly from the winding portion at an outside end of the winding portion;
a torsion spring comprising a winding portion wound spirally, a first extending arm extended outwardly from the winding portion at one end of the winding portion, and a second extending arm extended outwardly from the winding portion at another end of the winding portion;
a torsion spring comprising a first winding portion wound spirally, a second winding portion connected to the first winding portion and wound spirally, a first extending arm extended outwardly from the first winding portion at one end of the first winding portion, and a second extending arm extended outwardly from the second winding portion at another end of the second winding portion;
a bow-type spring;
a circular spring with a portion which is curved in a circle; and
a wave-type spring with bent portions alternatingly with intervals.

3. An elasticity module comprising:
a spring arm portion comprising first and second spring arms combined so as to have a sliding zone in which at least part of them latch each other slidingly in an overlapped position;
a rotating member connected to the first spring arm or the second spring arm so as to rotate in place; and
a spring with one end connected to the rotating member and the other end connected to one of the first and second spring arms which is not connected to the rotating member.

4. An elasticity module comprising:
a spring arm portion comprising first and second spring arms combined so as to have a sliding zone in which at least part of them latch each other slidingly in an overlapped position;
a connecting member disposed between the first spring arm and the second spring arm;
a first spring with one end connected to the connecting member and the other end connected to one of the first and second spring arms; and
a second spring with one end connected to the other end of the connecting member and the other end connected to one of the first and second spring arms which is not connected to the first spring.

5. The elasticity module of claim 1, wherein two or more springs are disposed with interval in the left-right direction.

6. The elasticity module of claim 1, wherein two or more springs are disposed as one stacked on top of the other.

7. The elasticity module of claim 1, wherein at least one of the first spring arm and the second spring arm comprises a connector configured to be connected to other member.

8. The elasticity module of claim 1, wherein at least one of the first spring arm and the second spring arm comprises a protrusion extended sideway, and the protrusion has a connector configured to be connected to other member.

9. The elasticity module of claim 1, wherein the first spring arm comprises a stopper for limiting to moving distance of the second spring arm, and the second spring arm comprises a latch configured to hook the stopper.

10. The elasticity module of claim 1, wherein the first spring arm or the second spring arm comprises hole, bumps, or rotational axle type connector.

11. The elasticity module of claim 1, wherein the spring is connected to the first spring arm and the second spring arm rotatably.

12. The elasticity module of claim 1, wherein the spring is connected to the first spring arm and the second spring arm rotatably, such that the direction of elastic force in the sliding zone changes according to rotating angle.

13. An elasticity module comprising a sliding zone in which at least some portions latch each other slidingly in an overlapped position, and further a first magnet arm and a second magnet arm with a magnetic force zone in which exert repelling or attracting force to each other along a sliding direction in the sliding zone.

14. The elasticity module of claim 13, wherein the first magnet aim and the second magnet arm are magnets for themselves, or comprise magnets attached thereto.

15. The elasticity module of claim 13, further comprising a spring disposed between the first and second magnet arms for applying elasticity to in-between the first and second magnet arms by an elastic deformation through the first magnet aim's translation against the second magnet arm over at least a part of the sliding zone.

16. A slide opening/closing apparatus according comprising:
a guiding member having a guiding means;
a sliding member combined to the guiding means and installed so as to move; and
an elasticity module according to claim 1 disposed between the guiding member and the sliding member, configured to push the sliding member in at least one direction of the guiding means in at least part of zone when the sliding member moves along the guiding means.

17. The slide opening/closing apparatus of claim 16, wherein the elasticity module comprises a spring connected to each of the first spring arm and the second spring arm rotatably and installed so as to change a direction of elastic force according to the rotating angle of the spring, and
the first spring arm is connected to the guiding member rotatably, and the second spring arm is connected to the sliding member rotatably.

18. The slide opening/closing apparatus of claim 17, wherein until the sliding member moves along the guiding means and opens from a closed state, or until the sliding member opens upward from a closed state after opened downward initially, the elasticity module comprises a first zone in which a distance between connectors on both ends decreases and a second zone in which the distance increases, and the spring is installed so as to change directions of the elastic force on the second spring arm through a rotational operation during each the first zone and the second zone, being configured to open in two steps or upwardly and downwardly.

19. A mobile device comprising:
a main body with a guiding means;
a movable body installed movably along the guiding means; and
an elasticity module according to claim 1, which is installed between the main body and the movable body and pushes the movable body in at least one direction of the guiding means in at least a part of zone when the movable body moves along the guiding means.

20. The mobile device of claim 19, wherein the elasticity module comprises a first spring arm, a second spring arm and a spring connected to each of the first spring arm and the second spring arm rotatably and installed so as to change a direction of elastic force according to the rotating angle of the spring, and
the first spring arm is connected to the main body rotatably, and the second spring arm is connected to the movable body rotatably.

21. The mobile device of claim 20, wherein until the movable body moves along the guiding means and opens from a closed state, or until the movable body opens upward from a closed state after opened downward initially, the elasticity module comprises a first zone in which a distance between connectors on both ends decreases and a second zone in which the distance increases, and the spring is installed so as to alternatingly change directions of the elastic force on the second spring arm through a rotational operation during each the first zone and the second zone, being configured to open in two steps or upwardly and downwardly.

22. A slide opening/closing apparatus comprising:
a guiding member having a guiding means;
a sliding member combined to the guiding means and installed so as to move; and
an elasticity module according to claim 13 disposed between the guiding member and the sliding member, configured to push the sliding member in at least one direction of the guiding means in at least part of zone when the sliding member moves along the guiding means,
wherein until the sliding member moves along the guiding means and opens from a closed state, or until the sliding member opens upward from a closed state after opened downward initially, the elasticity module may comprise a first zone in which a distance between connectors on both ends decreases and a second zone in which the distance increases, and the first magnet arm of the elasticity module may be installed so as to alternatingly change directions of the magnetic force on the second magnet arm of the elasticity module through a translational operation during each the first zone and the second zone, being configured to open in two steps or upwardly and downwardly.

23. A mobile device comprising:
a main body with a guiding means;
a movable body installed movably along the guiding means; and
an elasticity module using magnets according to claim 13, in which the first magnet arm of the elasticity module is connected to the main body rotatably, and the second magnet arm of the elasticity module is connected to the movable body rotatably,
wherein until the movable body moves along the guiding means and opens from a closed state, or until the movable body opens upward from a closed state after opened downward initially, the elasticity module comprises a first zone in which a distance between connectors on both ends decreases and a second zone in which the distance increases, and the first magnet arm is installed so as to alternatingly change directions of the magnetic force on the second magnet arm through a translational operation during each the first zone and the second zone, being configured to open in two steps or upwardly and downwardly.
